(19) United States
(12) Patent Application Publication
(10) Pub. No.: US 2016/0346870 A1
(43) Pub. Date: Dec. 1, 2016

(54) METHOD AND A SYSTEM FOR LASER MARKING A SUBSTRATE

(71) Applicant: JEANOLOGÍA, S. L., Paterna (ES)

(72) Inventors: Ramon SANS RAVELLAT, Paterna (ES); Martin HENDRYCH, Paterna (ES)

(73) Assignee: JEANOLOGÍA, S. L., Paterna (ES)

(21) Appl. No.: 15/097,436

(22) Filed: Apr. 13, 2016

(30) Foreign Application Priority Data
May 26, 2015 (EP) 15382277

(51) Int. Cl. B23K 26/00; B23K 26/082

(52) U.S. Cl. CPC B23K 26/0066; B23K 26/082

(57) ABSTRACT

A method and a system for laser marking a substrate for irradiating an area of a substrate with energizing radiation generated by an energizing radiation source to make said irradiated area require less laser energy to be laser marked; and irradiating a portion of said area with marking radiation from a marking laser beam generated from a marking laser source to laser mark said portion of said area. The irradiations from the energizing radiation source and from the marking laser source are at least partly overlapping each other in space and time, and are implemented by moving both the energizing radiation and the marking laser beam towards various areas of the substrate and portions thereof, respectively, in a synchronized manner.

### FIELD OF THE ART

The present invention generally relates, in a first aspect, to a method for laser marking a substrate, comprising irradiating those regions of the substrate to be marked with two different radiations in order to reduce laser marking energy required to produce laser marks, and particularly to a method comprising moving the radiations causing said irradiations in a synchronized manner along various regions of the substrate.

A second aspect of the invention relates to a system adapted for implementing the method of the first aspect.

The present invention is particularly applied to the laser marking of fabrics.

### PRIOR STATE OF THE ART

In the field of laser marking of objects, there are some prior art proposals aimed at minimizing the laser energy required for marking, either with the aim to use lasers of lower power or to increase the marking speed or both, and which are based on the heating (generally pre-heating) of the areas of the substrate to be marked. The following patent documents disclose the most relevant of said proposals.

JP2004017104A discloses a laser marker including pre-heating means for pre-heating the area of the substrate to be marked and a semiconductor laser for marking the pre-heated area. The use of a semiconductor laser of relatively low output is possible for marking because of the mentioned pre-heating of the area of the substrate to be marked.

In JP2004017104A the pre-heating means include a high power lamp or, for an alternative embodiment, the same marking laser diode, in which case said laser diode is used collimated in a pre-heating step and, after the pre-heating step, it is used condensed into a focused marking spot for the marking step.

EP1684986B1 discloses a laser marking system which uses a low energy laser array for marking a substrate, together with a heater to heat the substrate prior to radiating the substrate so that the energy required to be provided by the array of lasers for marking the substrate is minimized. For some embodiment, the heater for performing the pre-heating of the substrate is a light emitter, such as a laser. For all the embodiments disclosed in EP1684986B1 the heater is stationary, i.e., the pre-heating radiation is not moved.

International Application WO2011035909A1 discloses another proposal sharing the same concept with the above identified patent documents, related to the minimizing of the laser energy required for marking a substrate by additional submitting the area to be marked to a further irradiation which already energizes the same so that the combined irradiations causes the marking. This patent document discloses the features included in the preamble clause of the independent claims of the present invention, particularly at the last paragraph of its description when stating that the energizing irradiation and the marking irradiation can be applied at least partly overlapping each other in time.

In the proposal of WO2011035909A1, the energizing irradiation is applied to the complete laser sensitive area of the substrate which includes the portion to be laser marked, and, although there are disclosed embodiments for which the substrate is running and the marking is made on the fly and other embodiments for which the substrate to be marked may instead be stationary, moved in slow speed or moved by indexing a step at a time, none of said embodiments neither discloses nor suggests the moving of the energizing irradiation through various sensitive areas of the substrate.

### DESCRIPTION OF THE INVENTION

It is necessary to offer an alternative to the state of the art which covers the gaps found therein by the provision of a method and of a system which allows the laser marking of a substrate with a low energy laser and/or at high marking speeds along various areas of the substrate, thus allowing costs reduction and increase of the manufacturing productivity, i.e., the output per hour, when applied to an industrial process for laser marking of objects, such as articles of clothing.

To that end, the present invention provides a method for laser marking of a substrate, comprising:

a) irradiating an area of said substrate with energizing radiation generated by an energizing radiation source to make said irradiated area require less laser energy to be laser marked; and

b) irradiating a portion of said area with marking radiation from a marking laser beam generated from a marking laser source (such as a CO₂ laser source) to laser mark said portion of said area;

wherein, the irradiations from said energizing radiation source and from said marking laser source are at least partly overlapping each other in space and time.

Contrary to the method disclosed in WO2011035909A1, in the method of the first aspect of the present invention, in a characteristic manner, the irradiation of said step a) and the irradiation of said step b) are performed by directing both the energizing radiation and the marking laser beam towards various areas of said substrate and portions thereof, respectively, in a synchronized manner.

Said synchronized movements allow the laser marking of various regions of the substrate optimally, as, contrary to WO2011035909A1, the laser scanning is not performed along a stationary and fixed energized area, but through moving areas which are being energized while being laser marked and undergoing a required movement along the substrate.

For a preferred embodiment, the substrate is a fabric, such as denim, and constitutes or will be used to manufacture an article of clothing. None of the above mentioned prior art documents disclose the use of fabric substrates.

For an embodiment, at least said areas of the substrate are heat-sensitive, the energizing radiation source of step a) being a heat energy source selected to heat said areas.

For another embodiment, complementary or alternative to the above mentioned embodiment, at least said areas of the substrate are wavelength-sensitive for a specific wavelength, said radiation generated by said energizing radiation source of step a) being in the form of a radiation wave having said specific wavelength.

For an embodiment, the method of the first aspect of the present invention comprises performing said synchronized radiation movements such that at least some of said various areas of the substrate are partially overlapped and at least some of said portions thereof are included in the overlapped regions resulting from said areas overlapping. Hence, for this embodiment, the marking radiation is applied to a region which is being irradiated simultaneously with the energizing radiation but which has also been pre-energized by a previous irradiation with the energizing radiation, as said region includes at least one section of each of two consecutive of the mentioned areas of the substrate: a first one already energized and another being currently energized. This embodiment improves the results obtained with the method of the present invention, in terms of energy requirements for the marking laser and/or marking speed.

In this sense, the energy density for both, the energizing radiation and the marking laser beam, must be well calculated taking into account whether the laser marks will be made in overlapping energized regions or not.

Preferably, the energizing radiation source is an energizing laser source (such as a CO₂ laser source) configured and arranged to generate an energizing laser beam impinging on said areas of the substrate with a spot diameter approximately one order of magnitude larger than the spot diameter of the marking laser beam impinging on said portions of said areas.

For an embodiment, said spot diameter of the impinged zone of the energizing laser beam is in the order of several millimetres, while the spot diameter of the impinged zone of the marking laser beam is in the order of tens to hundreds of micrometres.

Such a spot diameter of the energizing laser beam when impinging on the substrate areas is achieved, for a preferred embodiment, by using a collimated energizing laser beam having a beam diameter coincident with said spot diameter, although for another less preferred embodiment the energizing laser beam is focused but to a focal plane which is in front or behind the substrate plane. In any case, the power density of the energizing laser beam when impinging on the substrate will be much lower than the power density of the marking laser beam when impinging on the substrate.

Other kind of energizing radiation sources are also covered by the present invention, according to less preferred embodiments, such as an infrared radiation source or a hot air radiation source.

In general, the marking laser source operates according to a pulsed laser mode, although its operation according to a continuous wave mode is also embraced by the present invention but less preferred.

As stated above, the irradiations from the energizing radiation source and from the marking laser source are at least partly overlapping each other in time, which means that, depending on the embodiment, both irradiations will start and end at the same moment, or that the irradiation from the energizing radiation source will start before the one from the laser marking radiation, the latter ending before or at the same time as the former.

A second aspect of the present invention relates to a system for laser marking a substrate, comprising:

first irradiating means comprising an energizing radiation source, which are configured and arranged to irradiate an area of said substrate with energizing radiation generated by said energizing radiation source, to make said irradiated area require less laser energy to be laser marked;

second irradiating means comprising a marking laser source, which are configured and arranged to irradiate a portion of said area with marking radiation from a marking laser beam generated by said marking laser source, and

control means configured and arranged to control the operation of said first and second irradiating means to make them work such that the irradiations from said energizing radiation source and from said marking laser source are at least partly overlapping each other in time.

Contrary to the system disclosed in WO2011035909A1, in the system of the second aspect of the present invention:

said first and second irradiation means comprise radiation redirecting means, and

said control means are configured and arranged to control the operation of said radiation redirecting means to make them move both the energizing radiation and the marking radiation beam, redirecting them towards various areas of said substrate and portions thereof, respectively, in a synchronized manner.

Preferably, the substrate is a fabric, such as denim.

According to an embodiment, the energizing radiation source is an energizing laser source configured and arranged to generate an energizing laser beam impinging on said areas of the substrate with a spot diameter approximately one order of magnitude larger than the spot diameter of the marking laser beam impinging on said portions of said areas.

For an embodiment, said radiation redirecting means comprises a joint light reflecting and/or light deflecting and/or light diffracting arrangement for redirecting both the energizing and the marking laser beams simultaneously towards said various areas of the substrate and portions thereof.

For a variant of said embodiment, the system of the second aspect of the invention comprises an optical combiner configured and arranged for combining the energizing and the marking laser beams such that the resulting combined laser beams enter said common light reflecting and/or light deflecting arrangement collinearly following a common optical path.

For an alternative variant of said embodiment, the optical axes of the energizing and the marking laser beams are inclined with respect to each other at the entry of said common light reflecting and/or light deflecting arrangement, and combined there within by a reflecting, deflecting or diffracting element such that they exit therefrom collinearly following a common path.

Said common light reflecting and/or light deflecting arrangement is, for a preferred embodiment, a galvanometer scanner, and, for another embodiment it comprises a polygon scanner.

According to another embodiment, alternative to the one described above, instead of said common light reflecting and/or light deflecting arrangement, the radiation redirecting means comprises two physically independent, but operationally synchronized, light reflecting and/or light deflecting arrangements (such as galvanometer scanners or polygon scanners), each for respectively redirecting one of said energizing and marking laser beams towards said various areas of the substrate and portions thereof.

### BRIEF DESCRIPTION OF THE DRAWINGS

The previously described advantages and other features will be more fully understood from the following detailed description of embodiments, with reference to the attached drawings, which must be considered in an illustrative and non-limiting manner, in which:

FIG. 1 schematically shows an optical arrangement including a galvanometer, for implementing the method of the first aspect of the invention, according to an embodiment, for laser marking a substrate, where the depicted elements form part of the system of the second aspect of the invention, for an embodiment;

FIG. 2 shows an arrangement similar to the one of FIG. 1 but with a different beam combiner, for another embodiment;

FIG. 3 schematically shows another optical arrangement, for another embodiment, which differs from the ones of FIGS. 1 and 2 in that it functions without a beam combiner before the galvanometer;

FIG. 4 shows two energizing laser spots performed in two corresponding overlapped areas of a substrate, according to an embodiment of the method of the first aspect of the present invention, and two marking laser spots performed in two portions of said areas centred with respect thereto.

FIGS. 5a and 5b show a row of n energizing laser spots performed in n corresponding overlapped areas of a substrate (overlapping of the areas A being different in the two figures), according to an embodiment of the method of the first aspect of the present invention, and a row of n marking laser spots performed in n respective portions of said areas, said n marking spots being aligned and suitable in case of overlapping to form a marking line;

FIG. 6 shows a block diagram of the system of the second aspect of the present invention, for an embodiment valid for implementing the method of the first aspect of the invention according to the embodiments of FIGS. 1 and 2, i.e., to the ones using a beam combiner and a common galvanometer; and

FIG. 7 schematically shows a further optical arrangement, for an embodiment which is alternative to the ones of FIGS. 1 and 2, which differs therefrom mainly in that it includes two independent galvanometers, one for the energizing beam and the other for the laser marking beam.

### DETAILED DESCRIPTION OF SEVERAL EMBODIMENTS

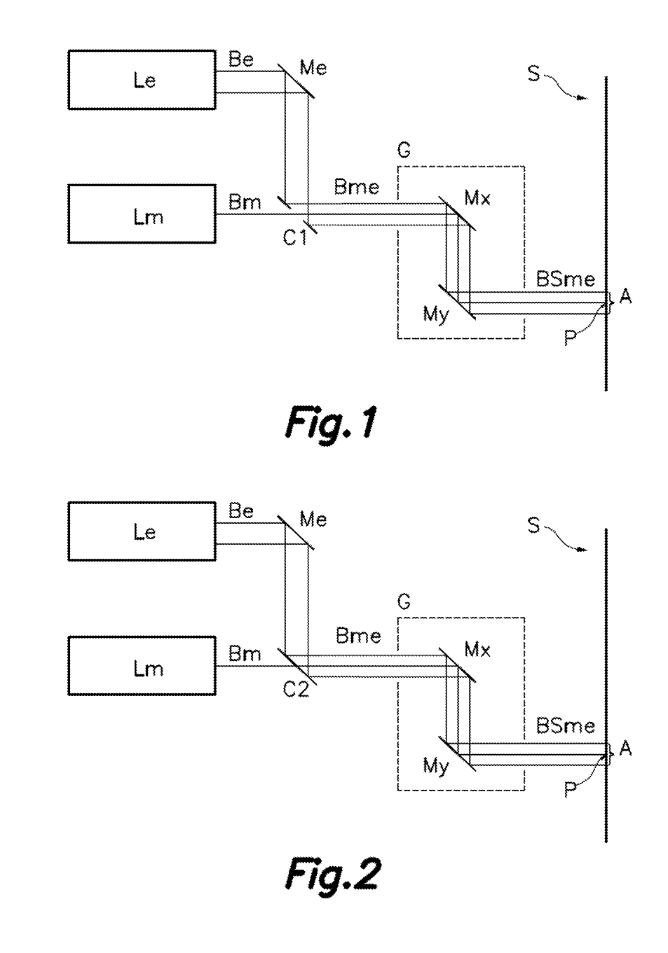

FIGS. 1-3 and 7 show different optical arrangements representative of different embodiments of the present invention, all of them including the above described energizing laser source Le generating an energizing laser beam Be in an area A, and the marking laser source Lm generating a marking laser beam Bm in an area or portion P.

For a non-limitative application example, the power density of the marking laser beam Bm when impinging on the substrate S is of the order of hundreds of MW/m² (such as of 600 MW/m²), which causes the volatilization of surface particles of the material, which when, for a preferred embodiment, the material of the substrate is denim (such as jeans), i.e., a dyed fabric, the fabric dye is eliminated (at least partially) which causes a worn look effect, while the power density of the energizing laser beam Be being when impinging on the substrate S is only of the order of a few MW/m² (such us 6 MW/m²) which does not cause a volatilization effect but a thermal transfer process which ultimately brings about an increase in the surface temperature. In fact, a diameter ratio A/P of the order of 10 results in the power density ratio of the order of 100.

By moving both beams Be and Bm simultaneously, in space and time, both the energizing (generally heating) of the regions to be marked (and surrounding regions) and the marking thereof are performed at a time, i.e., the marking laser energy is applied while the energizing laser energy is also being applied, even if deciding to mark different and distant regions of the substrate S following fast and intricate movements, as the movements of the marking laser beam Bm are synchronously followed by the movements of the energizing laser beam Be.

FIG. 4 shows how the energy is distributed on the substrate S, particularly in the laser impinging regions, by particularly showing two energized pulsed laser spots performed with beam Be in two corresponding overlapped areas A of the substrate S and two pulsed marking laser spots performed with beam Bm in two centred portions P of said areas A. The marks are only caused at portions P, as the energy threshold required for marking is only achieved in said portions P. The value of Δx is defined by the number of pixels n between the two focus points, i.e., between two consecutive portions P, each of these focus points being associated to a time, which is defined as pixel time p(t), where Δx =n·p(t). Therefore pixel time is the time during which each pixel is irradiated.

The present inventors have performed several experimental tests of laser marking on different kind of denims (pure indigo, sulphide indigo, viscose, etc.) with different power levels of the energizing laser beam Be, with one and even several consecutive steps for applying the laser marking beam Bm on the same spots, with and without pre-heating the substrate S, with different pixel times (shorter than the pixel times used when only Bm is applied), etc., and the obtained results have shown the suitability and accuracy of the present invention as compared with the proposals of the prior art, particularly due to the fact that the regions to be marked are submitted to the laser energy from both laser beams Be and Bm simultaneously, and thus said regions have not begun to de-energize/cool when Bm is applied thereto.

The results of said experimental tests also show that the different operative parameters of the system must be adjusted to each specific kind of fabric and to the dyes/pigments contained therein, in order to achieve the desired effect and not produce negative effects (such as dye thermal degradation) which could affect the quality and the colour of the final product.

Said results have also demonstrated that there are fabrics more suitable than others to be used as substrates for the method and system of the present invention.

All of the above mentioned optical arrangements, depicted in FIGS. 1-3 and 7, and which will be described below, allow obtaining the above mentioned synchronous beam movements.

First of all, it must be pointed out that the arrangements illustrated in said FIGS. 1-3 and 7 do not include, for the sake of clarity, all the elements of the system of the second aspect of the invention. Particularly, said Figures do not include the control means of the laser sources Le and Lm and of the galvanometer scanners G, G1, and G2. Said control means are depicted in FIG. 6 by means of block CU (CU standing for control unit) and their operation, associated to other intervening depicted elements, will be described below.

Also, for the sake of clarity, the depicted optical arrangements are simplified, where common elements, such as lenses and motors for moving mirrors Mx, My, Mx1, My1, Mx2, and My2 of galvanometer scanners G, G1 and G2, have not been depicted either, but their inclusion is covered by the present invention as they only represent slight modifications of the shown arrangements that do not require an inventive effort from a person skilled in the art.

Starting with the description of FIG. 1, the optical arrangement there shown includes a common galvanometer scanner G, including moving mirrors Mx and My, for moving together both beams Be and Bm, once the beams have been combined into combined beams Bme (two overlapped beams having different spatial features, in particular their diameter and divergence), by means of optical combiner C1, which is a special mirror having an aperture facing beam Bm which allows said beam Bm to pass therethrough towards mirror Mx and a reflecting surface facing mirror Me to reflect beam Be also towards mirror Mx. The combined beams have been indicated in FIG. 1 as Bme when entering the galvanometer scanner G and as BSme when exiting therefrom, the latter combined beams impinging on substrate S, particularly component Be on area A and component Bm on portion P.

The arrangement of FIG. 2 only differs from the one of FIG. 1 in that it includes a different beam combiner C2, particularly a conventional beam combiner which allows the passage of beam Bm therethrough while it reflects beam Be, redirecting both beams, combined in the form of Bme, towards the galvanometer scanner G. Beam combiner C2 could be a polarizing beam splitter and beams Be and Bm could have mutually orthogonal polarizations in order to reduce energy losses and to maximize the efficiency of the combining of the beams.

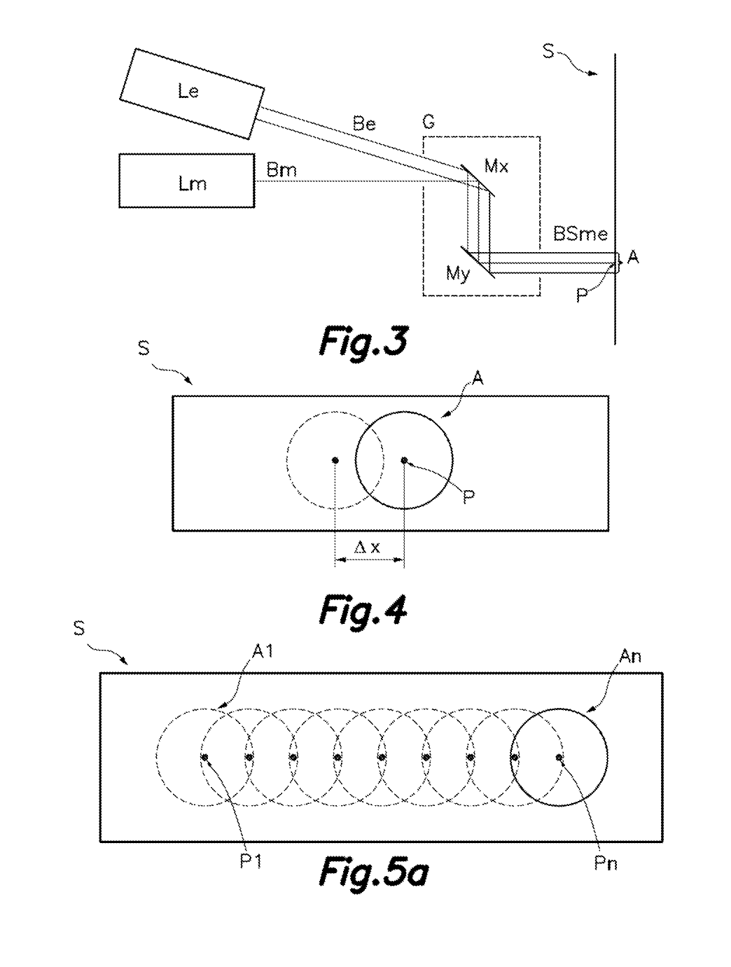

The arrangement of FIG. 3 operates without the mentioned beam combiner, by means of providing different optical paths for the beams Be and Bm, in this case by tilting energizing laser source Le such that beam Be follows an inclined path with respect to the path followed by Bm towards mirror Mx of the common galvanometer G. In this case, beams Be and Bm are combined within galvanometer G after been reflected by mirror Mx that could be a polarizing beam splitter, diffraction grating (Be and Bm may have different wavelengths), etc., such that they exit therefrom collinearly following a common path in the form of BSme.

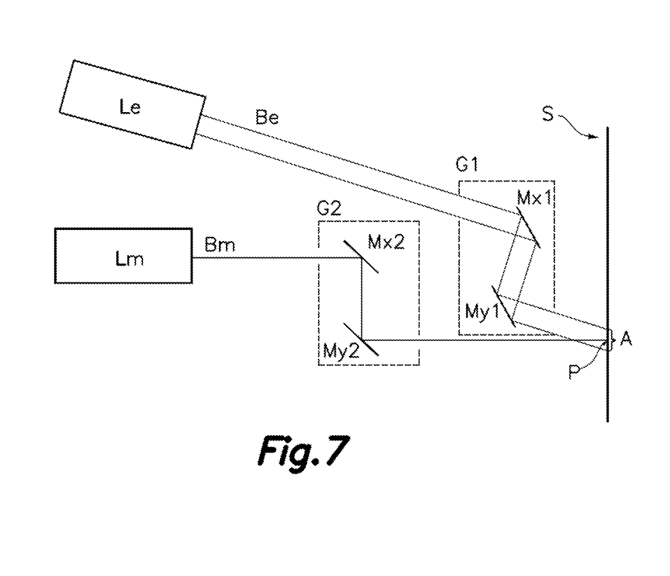

In contrast to the embodiments of FIGS. 1-3, the optical arrangement depicted in FIG. 7 does not include a common galvanometer but two galvanometers G1 and G2, which are physically independent but operationally synchronized, one (G1) for redirecting beam Be and the other one (G2) for redirecting beam Bm.

Although in FIGS. 1-3 and 7 only one area A of substrate S and one portion P thereof are illustrated as being impinged by beams Be and Bm, because said Figures illustrate a static view, during operation there will be a plurality of laser impinged areas A1 . . . An and corresponding portions P1 . . . Pn, when the beams Be and Bm are moved thereupon, whether independently but in a synchronous manner for the embodiment of FIG. 7, or jointly through combined beams BSme for the embodiments of FIGS. 1-3.

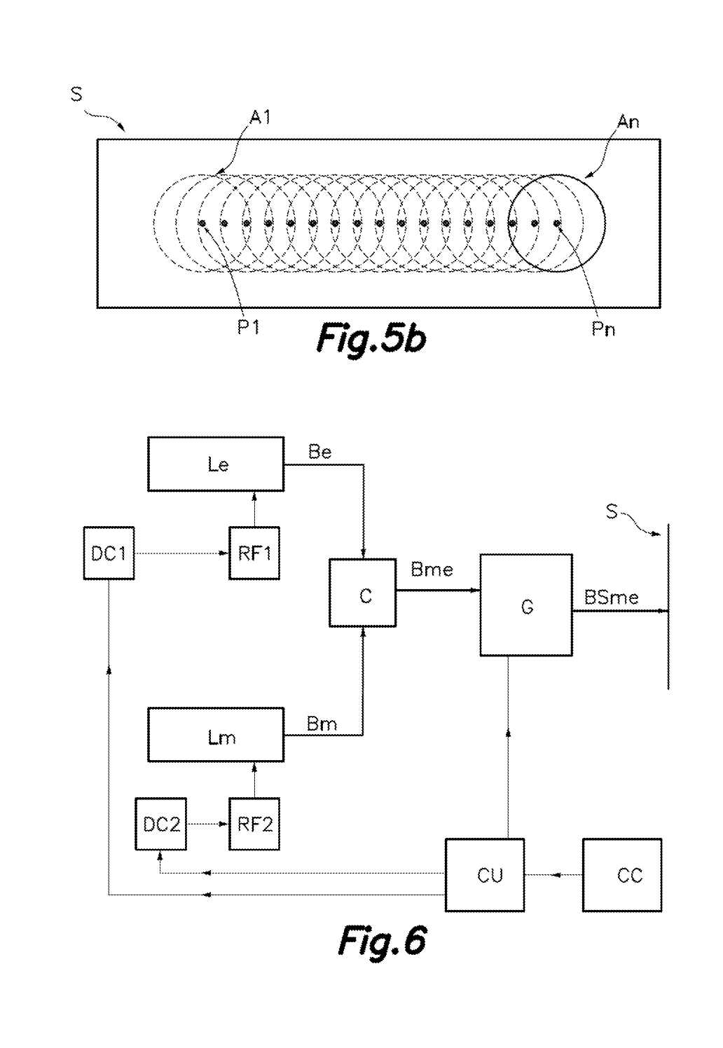

Those areas A1 . . . An and portions thereof P1 . . . Pn are depicted in FIGS. 5a and 5b, for an embodiment in which a marking line has been produced on substrate S, said marking line being formed by a row of n marking spots performed in n respective portions P1 . . . Pn of n areas A1 . . . An on which a row of n energized laser spots is produced, in this case with a much larger spot diameter than the marking spot diameter. The portions P1 . . . Pn, can be centred with regard to areas A1 . . . An, or not.

For the particular embodiment of FIGS. 5a and 5b, the consecutive areas A1 . . . An, are partially overlapped (regularly as in the Figure or irregularly), and the portions P1 . . . Pn can be included in the overlapped regions resulting from the overlapping of said areas. This means that, for portions P2 to Pn, the marking laser beam Bm is applied not only within an area being energised at the same time with laser beam Be but also within an area which had already been energized at a previous application of laser beam Be, i.e., to a pre-energized area. For example, the marking laser beam Bm is applied to P2 at the same time that Be is applied to A2 but also once Be had already been applied to Al at the time when Bm was applied to P1.

In another embodiment that has not been included in the drawings the areas A are not overlapped. This arrangement can be used in the case that a dotted or dashed line be created by laser marking.

The distinction between areas A1 . . . An and the distinction between portions thereof P1 . . . Pn, as shown in FIGS. 5a and 5b, and described above, is due to a pulsed mode operation of both laser beams Be and Bm, with each of said areas and portions corresponding to a laser pulse of, respectively, beams Be and Bm, i.e., each of the mentioned applications of Be and Bm is made in the form of a corresponding laser pulse. However, a continuous wave operation mode is also covered by the present invention, although for a less preferred embodiment, in which case the above described overlapping between areas would not occur as no discontinuities would exist between consecutive areas. Therefore any of the laser source Le for heating and any of the laser source LM for marking can, instead of a pulsating mode, be of a continuous wave mode.

Finally, FIG. 6 shows a block diagram of the system of the second aspect of the present invention, for an embodiment valid for implementing the method of the first aspect of the invention according to the embodiments of FIGS. 1 and 2, i.e., the ones using a beam combiner C and a joint galvanometer G, which apart from the optical arrangement of the system also shows, schematically, the control arrangement of the system, i.e., the control means CU controlling the operation of both laser sources Le and Lm and the operation of the common galvanometer G.

In FIG. 6, control lines have been depicted as thin lines and optical lines as thicker lines.

As shown in said FIG. 6, each of laser sources Le and Lm is respectively excited by a radio frequency source RF1 and RF2, which is supplied by a corresponding DC source DC1 and DC2. Other kinds of excitation sources for the laser sources Le and Lm are also possible for other embodiments (not shown) of the system of the second aspect of the invention (such as optical, electrical, gas-dynamical, chemical, or electron-beam pumping sources).

The DC supplied to the RF sources RF1 and RF2, and thus the excitation energy delivered to laser sources Le and Lm, is controlled by control unit CU, in order to control the generation of the laser beams Be and Bm, respectively.

As already described previously, with reference to FIGS. 1 and 2, combiner C combines both beams Be and Bm into overlapping beams Bme which enter joint galvanometer scanner G redirecting the entry beams Bme as output beams BSme towards the various areas A1 . . . An of substrate S within which portions P1 . . . Pn to be marked are situated.

Galvanometer scanner G is also controlled by control unit CU to modulate/scan the beams BSme (containing both beams Be and Bm) to produce the desired marking lines, according to marking patterns delivered from control computer CC and designed and/or inputted thereto by an operator.

A person skilled in the art could introduce changes and modifications in the embodiments described without departing from the scope of the invention, as it is defined in the attached claims. In particular the heating source could be of any type such us bombardment with electrons, protons or other particles, radio waves, etc., or the laser aimed to heat the various areas of the substrate could trigger an exothermic chemical reaction to heat the material to be marked instead of heating the substrate directly.

1. A method for laser marking a substrate, comprising:
a) irradiating an area of a substrate with energizing radiation generated by an energizing radiation source to make said irradiated area require less laser energy to be laser marked; and
b) irradiating a portion of said area with marking radiation from a marking laser beam generated by a marking laser source to laser mark said portion of said area;
wherein the irradiations from said energizing radiation source and from said marking laser source are at least partly overlapping each other in space and time; and
wherein said irradiation of said step a) and said irradiation of said step b) are performed by moving both the energizing radiation and the marking laser beam towards various areas of said substrate and portions thereof, respectively, in a synchronized manner.

2. The method according to claim 1, wherein said substrate is a fabric.

3. The method according to claim 1, wherein at least said areas of said substrate are:
heat-sensitive, with said energizing radiation source of step a) being a heat energy source selected to heat said areas, and/or
wavelength-sensitive for a specific wavelength, with said radiation generated by said energizing radiation source of step a) being in the form of a radiation wave having said specific wavelength.

4. The method of claim 1, further comprising: producing said synchronized radiation movements such that at least some of said various areas of said substrate are partially overlapped and one or more of said portions thereof are included in the overlapped regions resulting from the overlapping of said various areas.

5. The method according to claim 3, wherein said energizing radiation source is an energizing laser source configured and arranged to generate an energizing laser beam impinging on said areas of the substrate with a spot diameter several times larger than the spot diameter of the marking laser beam impinging on said portions of said areas.

6. The method according to claim 5, wherein said energizing laser source is configured and arranged to generate an energizing laser beam impinging on said areas of substrate with a spot diameter approximately one order of magnitude larger than the spot diameter of the marking laser beam impinging on said portions of said areas.

7. The method according to claim 5, wherein at least said marking laser source operates in a pulsed laser mode.

8. A system for laser marking a substrate, comprising:
first irradiating means comprising an energizing radiation source, which is configured and arranged to irradiate an area of a substrate with energizing radiation generated by said energizing radiation source, to make said irradiated area require less laser energy in order to be laser marked;
second irradiating means comprising a marking laser source, which is configured and arranged to irradiate a portion of said area with marking radiation from a marking laser beam generated by said marking laser source, and
control means configured and arranged to control the operation of said first and second irradiating means to make them work such that the irradiations from said energizing radiation source and from said marking laser source are at least partly overlapping each other in space and time;
wherein said first and second irradiation means comprise radiation redirecting means, and in that
said control means is configured and arranged to control the operation of said radiation redirecting means to make move both the energizing radiation and the marking laser beam redirecting them towards various areas of said substrate and portions thereof, respectively, in a synchronized manner.

9. The system according to claim 8, wherein said substrate is a fabric.

10. The system according to claim 8, wherein said energizing radiation source is an energizing laser source configured and arranged to generate an energizing laser beam impinging on said areas of the substrate with a spot diameter approximately one order of magnitude larger than the spot diameter of the marking laser beam impinging on said portions of said areas.

11. The system according to claim 10, wherein said radiation redirecting means comprises a joint light reflecting and/or light deflecting and/or light diffracting arrangement, for redirecting both the energizing and the marking laser beams simultaneously towards said various areas of the substrate and portions thereof.

12. The system according to claim 11, comprising an optical combiner configured and arranged for combining the energizing and the marking laser beams such that the resulting combined laser beams enter said joint light reflecting and/or light deflecting arrangement co-aligned following a common optical path.

13. The system according to claim 11, wherein the optical axes of the energizing and the marking laser beams are inclined with respect to each other at the entry of said joint light reflecting and/or light deflecting and/or light diffracting arrangement, and combined therewithin by a reflecting element such that they exit therefrom co-aligned following a common path.

14. The system according to claim 12, wherein said joint light reflecting and/or light deflecting arrangement is a galvanometer scanner, a polygon scanner or any other scanning mechanism.

15. The system according to claim 10, wherein said radiation redirecting means comprises two physically independent, but operationally synchronized, light reflecting and/or light deflecting arrangements, each for respectively redirecting one of said energizing and marking laser beams towards said various areas of the substrate and portions thereof.
